(19) United States
(12) Patent Application Publication
(10) Pub. No.: US 2009/0197655 A1
(43) Pub. Date: Aug. 6, 2009

(54) COMBINE THRESHING COMPONENTS

(76) Inventor: Michael B. Ellingson, Sherwood, ND (US)

Correspondence Address: WESTMAN CHAMPLIN & KELLY, P.A., SUITE 1400, 900 SECOND AVENUE SOUTH, MINNEAPOLIS, MN, 55402, US

(21) Appl. No.: 12/361,968

(22) Filed: Jan. 29, 2009

Related U.S. Application Data
(60) Provisional application No. 61/063,263, filed on Feb. 1, 2008.
(60) Provisional application No. 61/063,203, filed on Feb. 1, 2008.

(51) Int. Cl. A01F 12/20; A01D 41/12

(52) U.S. Cl. 460/71

(57) ABSTRACT

Combine threshing assemblies are provided. Combine threshing assemblies illustratively include a rotatable member having a cylindrical shaped outer surface. In some embodiments, a first and a second row of bars are secured to the cylindrical shaped outer surface. Each bar in the first row is illustratively distributed along the circumference of the cylindrical shaped outer surface such that each bar in the first row is separated from each other bar in the first row by an angle that is greater than forty-five degrees. Each bar in the second row is illustratively distributed along the circumference of the cylindrical shaped outer surface such that each bar in the second row is separated from each bar in the first row by at least half of the angle.

The present application is based on and claims the benefit of U.S. provisional patent application Ser. No. 61/063,203 filed on Feb. 1, 2008 and U.S. provisional patent application Ser. No. 61/063,263 filed on Feb. 1, 2008, the contents of both applications hereby incorporated by reference in their entireties.

### BACKGROUND

Combines that are used in harvesting crops commonly include a threshing assembly. Threshing assemblies separate the desirable portions of a crop from the undesirable portions. For example, a combine harvesting wheat may cut and collect both the desirable wheat grain and other undesirable components of the wheat plant such as stems. Threshing assemblies can be used to physically detach the desirable grain from the stems and then separate the grain from the stems such that only the desirable grain portion is saved.

A goal within the industry is to improve the ability of threshing assemblies to separate the desirable portions from the undesirable portions. Other goals include reducing the amount of time and energy needed in setting-up and operating threshing assemblies.

### SUMMARY

Combine threshing assemblies are provided. Combine threshing assemblies illustratively include a rotatable member having a cylindrical shaped outer surface. In some embodiments, a first and a second row of bars are secured to the cylindrical shaped outer surface. Each bar in the first row is illustratively distributed along the circumference of the cylindrical shaped outer surface such that each bar in the first row is separated from each other bar in the first row by an angle that is greater than forty-five degrees. Each bar in the second row is illustratively distributed along the circumference of the cylindrical shaped outer surface such that each bar in the second row is separated from each bar in the first row by at least half of the angle.

### BRIEF DESCRIPTION OF THE DRAWINGS

FIG. 1 is a schematic diagram of one embodiment of a threshing assembly.

FIG. 2-1 is a perspective view of a rotor assembly.

FIG. 2-2 is a schematic diagram of the outer surface of rotor assembly of FIG. 2-1.

FIG. 3-1 is a perspective view of a rotor assembly.

FIG. 3-2 is a schematic diagram of the outer surface of the rotor assembly of FIG. 3-1.

FIGS. 4-1, 4-2, and 4-3 are schematic diagrams of outer surfaces of rotor assemblies.

FIG. 5-1 is a perspective view of a left-handed thresher/separator bar.

FIG. 5-2 is a perspective view of a right-handed thresher/separator bar.

FIG. 5-3 is a perspective view of one thresher bar tooth.

FIG. 5-4 is a schematic cross-sectional view of the thresher/separator bars of FIGS. 5-1 and 5-2.

FIG. 6-1 is a top view of an alternative left-handed thresher/separator bar.

FIG. 6-2 is a top view of an alternative right-handed thresher/separator bar.

FIG. 7-1 is a top view of another alternative left-handed thresher/separator bar.

FIG. 7-2 is a top view of another alternative right-handed thresher/separator bar.

FIG. 8-1 is a perspective view of a modular concaves assembly.

FIG. 8-2 is a perspective view of a modular concaves assembly frame.

FIG. 8-3 is a perspective view of modular concaves assembly modules.

### DETAILED DESCRIPTION

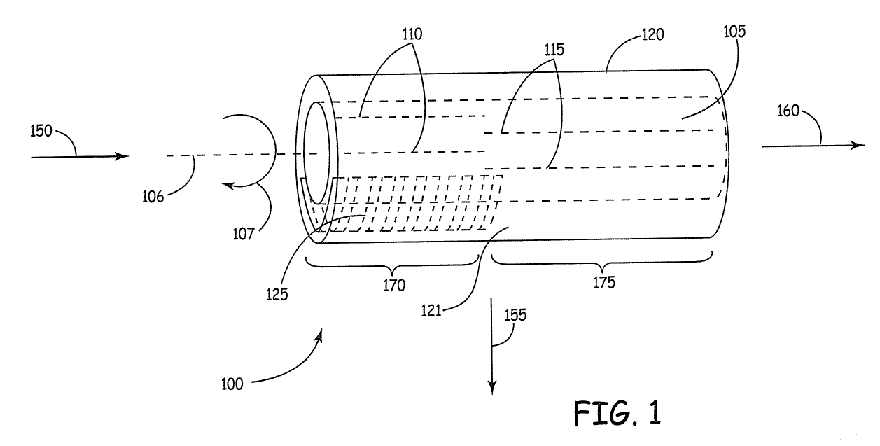

FIG. 1 is a schematic diagram of a threshing assembly 100. Assembly 100 is an example of a device in which some embodiments of the present disclosure may be incorporated. While embodiments of this disclosure are described in terms of assembly 100, variations on assembly 100 and other assemblies and systems should be considered within the scope of the present disclosure. Assembly 100 includes a threshing cylinder or rotor 105 that rotates about an axis 106 in the direction shown by arrow 107. The outer surface of rotor 105 includes thresher bars 110 and separator bars 115. Rotor 105 is positioned within and partially enclosed by a threshing channel 120. A portion of channel 120 includes concaves 125.

FIG. 1 also includes brackets 170 and 175. Brackets 170 and 175 divide assembly 100 into two illustrative sections. The section represented by bracket 170 is the thresher section, and the section represented by bracket 175 is the separator section.

Incoming crops enter assembly 100 in the direction shown by arrow 150. The crops enter the space between the outer surface of rotor 105 and the inner surface of threshing channel 120 or enter the space between the outer surface of rotor 105 and concaves 125. The incoming crops include desirable portions such as grain and undesirable portions such as plant stems, chaff, and straw. In thresher section 170, the rotating thresher bars 110 exert force on the crops against concaves 125 and mechanically separate most of the desirable portions from the undesirable portions. For example, wheat grain is removed from the head of the plant by a thresher bar impacting the grain and the head against concaves 125.

Once the grain has left thresher section 170 and has entered separator section 175, some of the desirable portion still remains. Separator bars 115 illustratively also separate at least some of the desirable portion from the undesirable portion.

Threshing channel 120 illustratively has a bottom portion 121 that has perforated holes running along the length of the channel. The desirable portion of the crop that was separated from the undesirable portion in either threshing section 170 or separator section 174 leaves the threshing assembly 100 through the perforated holes as is shown by arrow 155. In one embodiment, the material that leaves through the perforated holes enters a shoe that includes two sieves that further separate the desirable and undesirable portions.

Finally, the portion of the crops that has not been separated out of assembly 100 is moved through the assembly by separator bars 115. This portion leaves assembly 100 through the discharge end of assembly 100 as is shown by arrow 160. This portion commonly still includes at least some amount of desirable portion and it is referred to as “rotor loss.”

Embodiments of various combine threshing components are described in this disclosure. Some embodiments reduce loss of desirable material during combining. Some embodiments also provide other benefits such as, but not limited to, reduced time or personpower requirements for harvesting crops or setting up machines, reduced wear of combine threshing components and associated parts like motors and belts, reduced fuel costs, and reduced component costs or repair costs.

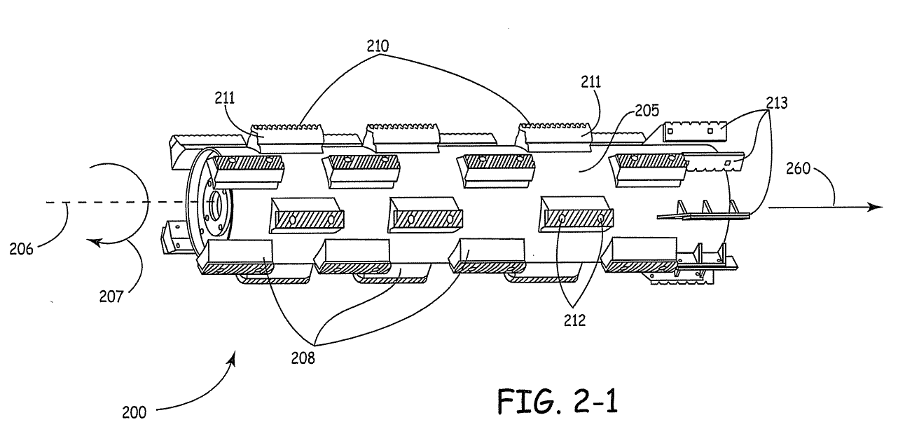

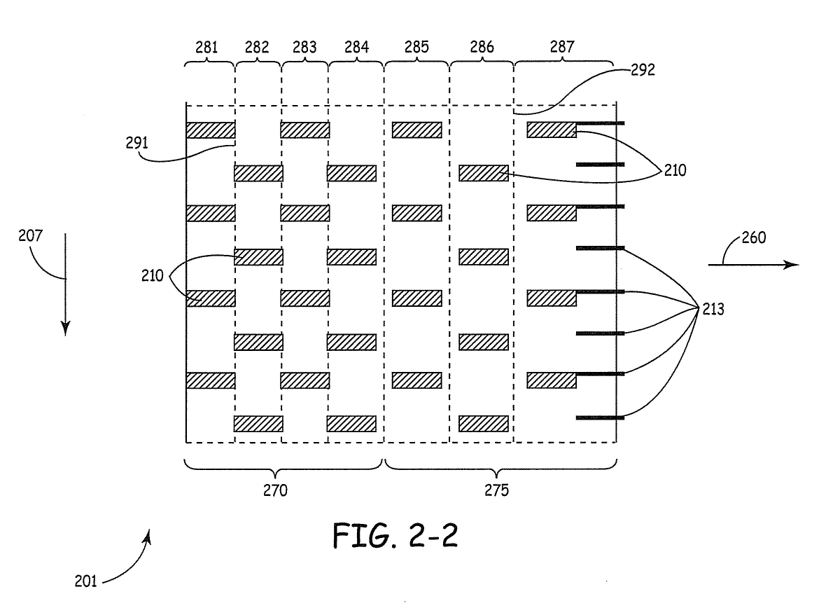

FIG. 2-1 is a perspective view of a rotor assembly 200. Rotor assembly 200 is illustratively included in threshing assemblies such as threshing assembly 100 shown in FIG. 1. Rotor assembly 200 includes a threshing cylinder or rotor 205 that is illustratively a rotor such as rotor 105 in FIG. 1. Rotor 205 rotates about axis 206 in the direction shown by arrow 207. Assembly 200 includes mounting brackets 208 (three are labeled in FIG. 2-1) and thresher/separator bars 210 (two are labeled in FIG. 2-1). Mounting brackets 208 enable bars 210 to be secured to rotor 205. In one embodiment, brackets 208 are separate from rotor 205 (i.e., separate pieces) and are welded onto or otherwise attached to rotor 205. In another embodiment, brackets 208 and rotor 205 are formed as one piece. Brackets 208 are however not limited to any particular structure or method of manufacture. Bars 210 optionally include flanges 211 (two are labeled in FIG. 2-1). Flanges 211 cover the leading edge or surface of the brackets and protect the brackets during use. Each bar 210 is illustratively secured to a bracket 208 using two screws 212 (two are labeled in FIG. 201). Many methods of attaching or securing a bar to a bracket are known in the art however and embodiments of the present disclosure are not limited to any particular hardware or methods. Assembly 200 also includes discharge paddles 213. Paddles 213 operate along with the separator bars to remove or discharge the undesirable portions of the crops from a threshing assembly in the direction shown by arrow 260.

FIG. 2-2 is a schematic diagram of the outer surface 201 of rotor assembly 200. FIG. 2-2 shows the surface of assembly 200 from the perspective of one side of the cylinder or rotor 205 being cut and the surface being laid flat. FIG. 2-2 is useful in showing the layout of the features on the surface of rotor assembly 200.

FIG. 2-2 includes many of the same components shown in FIG. 2-1 such as bars 210, discharge paddles 213, direction of rotation 207, and direction of discharge 260. FIG. 2-2 also includes brackets 270, 275, 281, 282, 283, 284, 285, 286, and 287. Bracket 270 represents the thresher section and is analogous to bracket 170 shown in FIG. 1. Bracket 275 represents the separator section and is analogous to bracket 175 in FIG. 1. Brackets 281, 282, 283, 284, 285, 286, 287, and their accompanying imaginary dotted lines represent rows of bars 210.

Surface 201 includes seven rows of bars, 281-287. Each row includes four bars. Those skilled in the art will recognize that locations on the surface of a cylinder can be defined by a distance along the length of the cylinder and by an angle along the circumference of the cylinder. The bars in each row are located at or approximately at the same distance along the length of the cylinder such that the bars in row 281 are at or approximately at a first distance along the length of the cylinder, the bars in row 282 are at or approximately at a second distance along the length of the cylinder, and so on.

The bars 210 in each row are illustratively evenly spaced or approximately evenly spaced along the circumference of the cylinder such that the bars are separated by or approximately by ninety degrees. The bars in adjacent rows (e.g. row 282 is adjacent to rows 281 and 283) are spaced along the circumference such that they are between bars in the adjacent rows (i.e. separated by an angle such as, but not limited to, forty-five or approximately forty-five degrees). It is also important to note that spacing between rows in the thresher section 270 (i.e. rows 281, 282, 283, and 284) is illustratively narrower or less than the spacing between rows in the separator section 275 (i.e. rows 285, 286, and 287). The row spacing in the thresher section is illustratively narrow enough such that ends of bars 210 in adjacent rows overlap in the direction of rotation (e.g. imaginary line 291 passes through the ends of bars 210 in both rows 281 and 282). The row spacing in the separator section 275 is illustratively wide enough such that ends of bars 210 in adjacent rows do not overlap in the direction of rotation (e.g. imaginary line 292 runs between the bars in rows 286 and 287 without touching bars in either row).

Surface 201 illustratively includes eight discharge paddles 213 (five are labeled in FIG. 2-2) that are distributed approximately forty-five degrees apart from each other. In another embodiment, only four discharge paddles 213 are included and they are spaced approximately ninety degrees apart from each other. Embodiments of the present disclosure include any number of discharge paddles 213 including none, and are not limited to any particular spacing or positioning.

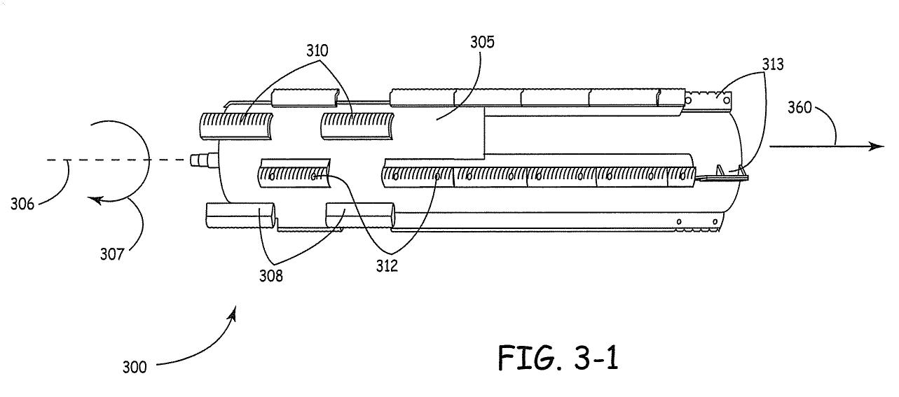

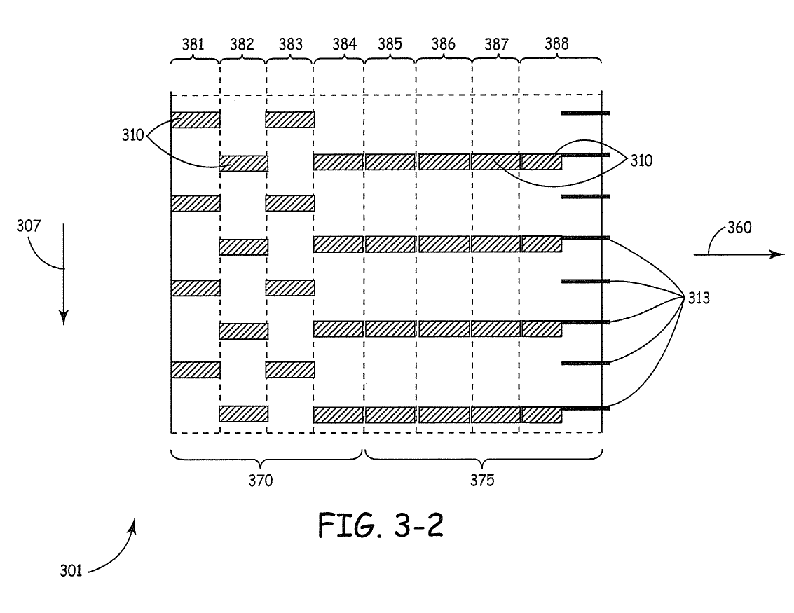

FIG. 3-1 is a perspective view of a rotor assembly 300. Rotor assembly 300 is a rotor assembly like assembly 200 in FIG. 2-1 and is also illustratively included in threshing assemblies such as threshing assembly 100 shown in FIG. 1. Assembly 300 includes many components that are the same or similar to assembly 200 and the components are numbered accordingly. Assembly 300 includes a threshing cylinder or rotor 305 that rotates about an axis 306 in the direction shown by arrow 307. Assembly 300 also includes brackets 308, bars 310, screws 312, discharge paddles 313, and a direction of discharge 360.

FIG. 3-2 is a schematic diagram of the outer surface 301 of rotor assembly 300. FIG. 3-2 shows the surface of assembly 300 from the perspective of one side of the cylinder or rotor 305 being cut and the surface being laid flat. FIG. 3-2 is useful in showing the layout of the features on the surface of rotor assembly 300. FIG. 3-2 includes many of the same components shown in FIG. 3-1 such as bars 310, discharge paddles 313, direction of rotation 307, and direction of discharge 360. FIG. 3-2 also includes brackets 370, 375, 381, 382, 383, 384, 385, 386, 387, and 388. Bracket 370 represents the thresher section and is analogous to bracket 170 shown in FIG. 1 and bracket 270 shown in FIG. 2-2. Bracket 375 represents the separator section and is analogous to bracket 175 in FIG. 1 and bracket 275 in FIG. 2-2. Brackets 381, 382, 383, 384, 385, 386, 387, and 388, and their accompanying imaginary dotted lines represent rows of bars 310.

The bars 310 in first four rows in FIG. 3-2, namely rows 381, 382, 383, and 384, are illustratively arranged the same or similarly to the first four rows in FIG. 2-2, namely rows 281, 282, 283, and 284. The bars in the separator section are however arranged differently. In one embodiment, each row in the separator section 375 has four bars 210 and the bars in adjacent rows are aligned to each other (as opposed to the being offset by approximately forty-five degrees as is shown in FIG. 2-2). The bars in the separator section are illustratively aligned with the last row of bars in the thresher section, row 384. In another embodiment, the bars in the separator section are offset from the last row of bars in the thresher section by an angle such as, but not limited to, forty-five degrees (i.e. the bars in row 384 are not aligned to the bars in row 385).

FIG. 3-2 includes eight discharge paddles 313 spaced apart by approximately forty-five degrees. In one embodiment, only four paddles 313 are included and they are spaced apart by approximately ninety degrees. Embodiments of assembly 300 include any number of paddles 313 including none, and are not limited to any particular spacing or positioning.

In one embodiment, the tubes or outer cylindrical surfaces of threshing cylinders or rotors such as rotor 205 in FIG. 2-1 and rotor 305 in FIG. 3-1 have a diameter of eighteen or twenty inches across both the threshing section and the separator section. In another embodiment, the tubes of cylinders or rotors have different diameters between the thresher section and the separator section. For example, rotor 305 shown in FIG. 3-1 illustratively has a twenty inch diameter tube along the thresher section and an eighteen inch diameter tube along the separator section. Embodiments of rotors and cylinder tubes include all diameters and combinations of diameters, and are not limited to any particular diameter or combination of diameters. It should also be noted that in an embodiment, the outer diameter of the entire cylinder or rotor (i.e. the diameter of the tube plus the height of other components attached to the tube such as, but not limited to, brackets, risers, and/or bars) is the same regardless of the tube diameter. For example, in one embodiment, the outer diameter of a cylinder or rotor with an eighteen inch tube is twenty-five inches, and the outer diameter of a cylinder or rotor with a twenty inch tube is also twenty-five inches. The outer diameter of cylinders or rotors is illustratively adjusted by increasing or decreasing the heights or sizes of the brackets, rise, and/or bars attached to the tubes. In another embodiment, the outer diameter of the entire cylinder or rotor is adjusted such that it matches the diameter of a concaves unit. It is also worth noting that embodiments of the present disclosure are not limited to any particular materials or methods of making rotors or cylinders. For example, rotors or cylinders are optionally hollow or approximately hollow, or solid or approximately solid.

FIGS. 4-1, 4-2, and 4-3 are schematic diagrams of other embodiments of outer surfaces of rotor assemblies. The surfaces shown in FIGS. 4-1, 4-2, and 4-3 are related in that they have the same or similar layout in their thresher sections 470. The surfaces however vary in that they have different layouts in the separator sections 475.

FIGS. 4-1, 4-2, and 4-3 each include thresher/separator bars 411 (three bars are labeled in each figure), a direction of rotation 407, a direction of discharge 460, and rows 481, 482, 483, and 484. As was previously mentioned, in an embodiment, the bars 411 in the thresher sections 470 of FIGS. 4-1, 4-2, and 4-3, namely the bars in rows 481 and 482, are laid out in the same or similar fashion. In one embodiment, each row includes four bars that are spaced at or approximately at ninety degrees from each other. The bars in adjacent rows in the thresher section (i.e. rows 481 and 482) are offset from each other at an angle such as, but not limited to, forty-five degrees. Additionally, in an embodiment, bars in adjacent rows, including bars in the separator section, overlap in the direction of rotation (e.g. imaginary lines 491 and 492 overlap bars in adjacent rows).

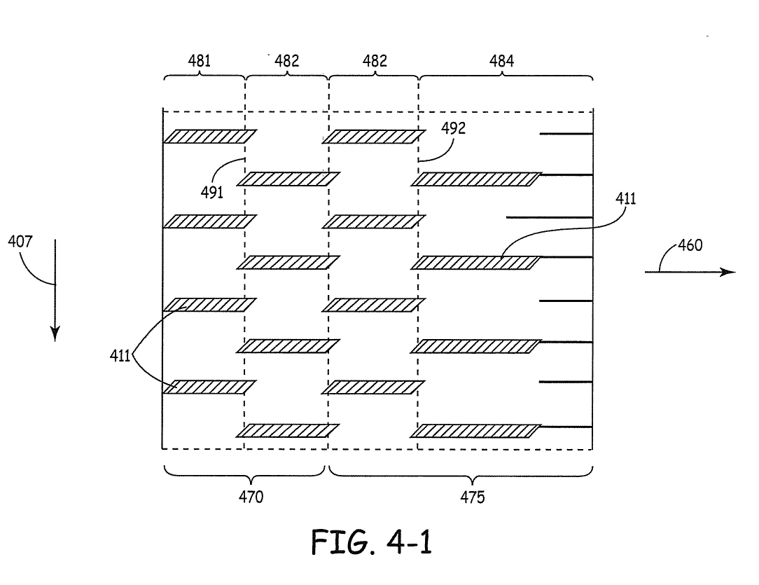

In FIG. 4-1, the bars in the separator section (i.e. the bars in rows 483 and 484) are offset from each other and from the bars in the thresher section (i.e. the bars in row 482). The bars are illustratively offset by an angle such as, but not limited to, approximately forty-five degrees. In FIG. 4-2, the bars in the separator section (i.e. the bars in rows 483 and 484) are aligned to each other, but are offset from the adjacent row of bars in the thresher section (i.e. row 482). In FIG. 4-3, the bars in the separator section (i.e. the bars in rows 483 and 484) are aligned to each other, and are also aligned to the adjacent row of bars in the thresher section (i.e. row 482). In an embodiment, the more the bars in adjacent rows in the separator section are aligned to each other and to bars in the thresher section, the faster material is discharged from a threshing assembly such as assembly 100 in FIG. 1. For example, the embodiment in FIG. 4-3 illustratively discharges material the quickest, the embodiment in FIG. 4-1 the slowest, and the embodiment in FIG. 4-2 slower than the embodiment in FIG. 4-3 but faster than the embodiment in FIG. 4-1.

The cylinder or rotor assemblies shown in FIGS. 2-1, 2-2, 3-1, 3-2, 4-1, 4-2, and 4-3 each show four bars per a row that are spaced apart by or approximately by ninety degrees. Embodiments of the present disclosure are not however limited to four bars per a row or spacing of approximately ninety degrees. Other embodiments include two bars in a row spaced apart by or approximately by one hundred and eighty degrees, three bars in a row spaced apart by or approximately by one hundred and twenty degree, five bars in a row spaced apart by or approximately by seventy-two degrees, six bars in a row spaced apart by or approximately by sixty degrees, and seven bars in a row spaced apart by or approximately by fifty-one degrees.

The cylinder or rotor assemblies shown in FIGS. 2-1, 2-2, 3-1, 3-2, 4-1, 4-2, and 4-3 each also shows the same number of bars in each of their rows, namely four. Embodiments of the present disclosure also include assemblies that have different numbers of bars in their rows. For example, for illustration purposes only and not by limitation, a cylinder or rotor assembly includes a row with three bars in one row, four bars in another row, and five bars in another row.

Additionally, the cylinder or rotor assemblies shown in FIGS. 2-1, 2-2, 3-1, 3-2, 4-1, 4-2, and 4-3 show four, seven, and eight rows. Embodiments of the present disclosure are not however limited to these numbers of rows. Other embodiments include any number of rows such as from two rows to twenty rows. Embodiments of the present disclosure are also not limited to any particular offsets between bars in adjacent rows. Bars in adjacent rows are illustratively aligned to each other or are positioned between bars in adjacent rows (i.e. positioned an equal distance between the two closest bars in an adjacent row). Bars in adjacent rows can however include any offset. Embodiments of the present disclosure also include combinations of various spacings between adjacent rows. For example, some rows may be aligned while others are offset.

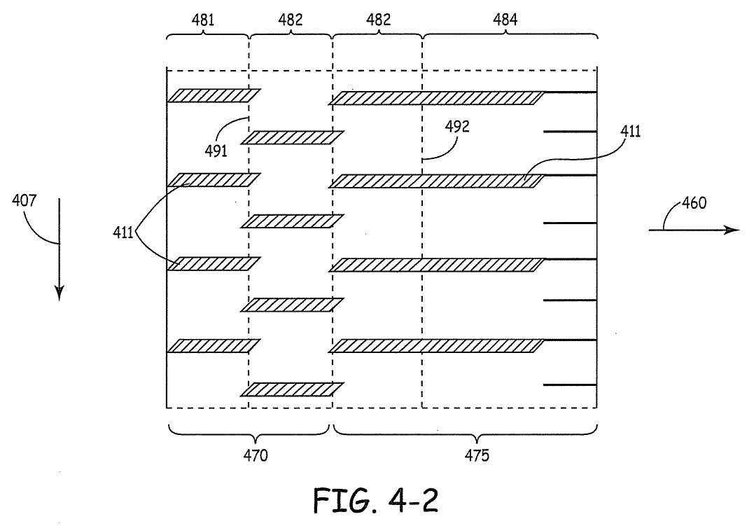

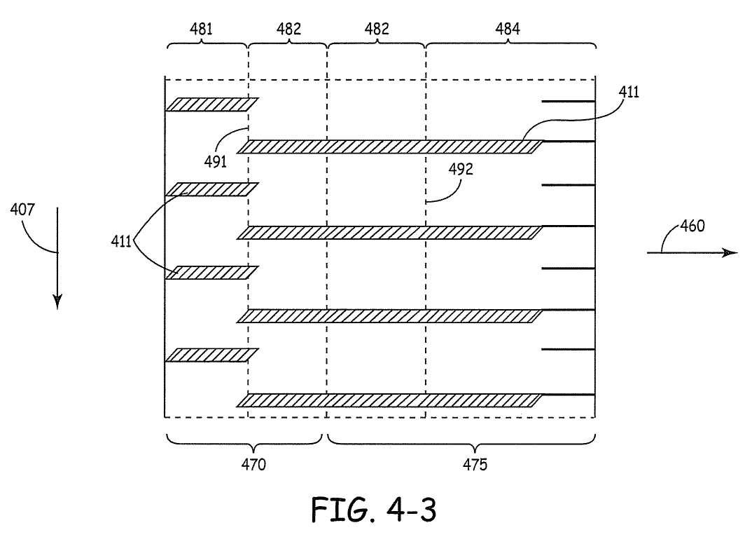

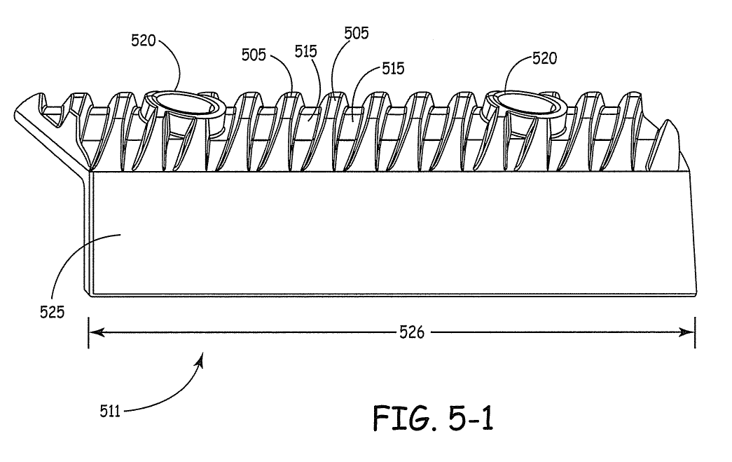

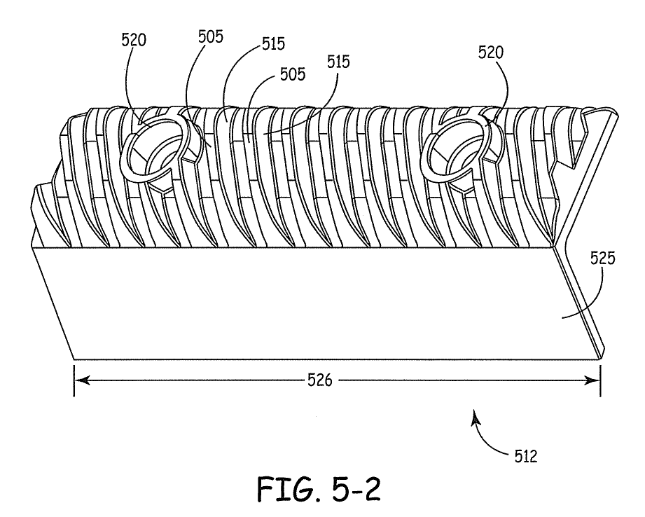

FIG. 5-1 is a perspective view of a left-handed thresher/separator bar 511, and FIG. 5-2 is a perspective view of a right-handed thresher/separator bar 512. Bars 511 and 512 are illustratively included in assemblies such as assembly 100 in FIG. 1, assembly 200 in FIG. 2-1, and assembly 300 in FIG. 3-1.

FIGS. 5-1 and 5-2 show that bars 511 and 512 include multiple teeth 505, gaps between teeth 515, protective circles 520, and flanges 525. Teeth 505 illustratively make contact with crops and separate or work to separate the crop into desirable and undesirable portions. Teeth 505 also illustratively work to move crops from the intake side to the discharge side. Protective circles 520 are optional. In an embodiment of bars 511 and 512, no protective circles are included. Circles 520 protect items such as bolts and screws such as screws 212 shown in FIG. 2-1 from wear by preventing or reducing direct contact with crops or other materials in the threshing assembly such as, but not limited to, rocks and stumps. Flange 525 is also optional. In an embodiment of bars 511 and 512, no flange is included. Flange 525 is illustratively mounted on a bracket such as bracket 208 shown in FIG. 2-1 such that the flange covers the leading edge of the bracket (i.e. the edge or surface of the bracket that leads in the direction of rotation). Flange 525 illustratively protects a bracket by preventing or reducing direct contact with crops or other materials in the threshing assembly.

FIGS. 5-1 and 5-2 also show that bars 511 and 512 each have a length 526. In an embodiment, length 526 is between three and twenty-two inches. Embodiments of bars 511 and 512 are not however limited to any particular dimensions.

FIG. 5-3 is a perspective view of one thresher bar tooth 505. The top of tooth 505 has a width 507 and a length 506, and is illustratively a planar or approximately planar surface (i.e. a flat or approximately flat surface). The top surface of every tooth in a bar such as bars 511 and 512 in FIGS. 5-1 and 5-2, illustratively lie in or approximately in the same plane as one another (i.e. they are coplanar). Width 507 is illustratively greater than two-tenths of an inch and length 506 is illustratively greater than five-tenths of an inch. In one embodiment, width 507 is one-quarter of an inch and length 506 is one and one-quarter inches. Embodiments of the present disclosure are not however limited to any particular tooth top widths and lengths and include all dimensions.

FIG. 5-3 shows that tooth 505 also includes a depth 508. In certain embodiments, depth 508 is less than that found in conventional bars. Depth 508 is illustratively less than four-tenths of an inch. In one embodiment, depth 508 is five-sixteenths of an inch. FIG. 5-3 further shows that the width of the teeth increases going from top to the bottom (i.e. the tooth width is the smallest at top width 507 and increases along tooth depth 508). In another embodiment, teeth have a constant width. Embodiments of the present disclosure are not however limited to any particular tooth depths or widths and include all dimensions.

FIG. 5-3 also shows that tooth 505 includes a leading edge 509 and a trailing edge 510. Edges 509 and 510 illustratively extend from the top of each tooth to the bottom of each tooth. As is shown in FIG. 5-3, in one embodiment, for illustration purposes only and not by limitation, the edges of the teeth are rounded such that there are no sharp or pointy edges (i.e. there is a continuous smooth curve going from a tooth top to a tooth bottom).

FIG. 5-4 is a schematic cross-sectional view 513 of bars 511 and 512. Cross-section 513 includes top surface 531 and bottom surface 532. Bottom surface 532 illustratively makes contact with and rests on a bracket such as bracket 208 shown in FIG. 2-1. Top surface 531 is illustratively formed at least in part by the tops of teeth. As was discussed previously, in an embodiment, the tops of teeth form a flat or approximately flat surface. It is also worth noting that FIG. 5-4 also shows that teeth 505 illustratively have rounded corners or profiles (i.e. no sharp or pointy corners) similar to as was shown with the rounded leading and trailing edges in FIG. 5-3. Embodiments of the present invention are not however limited to any particular profile.

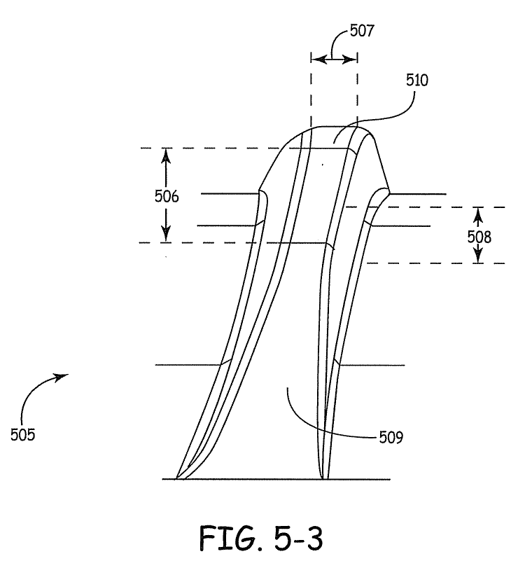

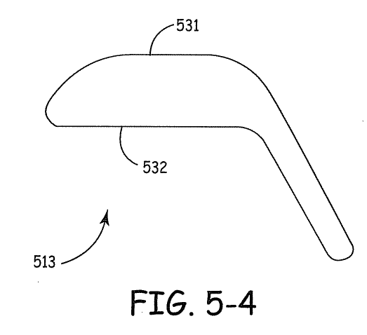

FIG. 6-1 is a top view of an alternative left-handed thresher/separator bar 611, and FIG. 6-2 is a top view of an alternative right-handed thresher/separator bar 612. Bars 611 and 612 include similar components and features as bars 511 and 512 shown in FIGS. 5-1, 5-2, 5-3, and 5-4 and are numbered accordingly. Bars 611 and 612 include teeth 605, gaps 615, mounting holes 620, a length 626, a left end 627, and a right end 628.

FIGS. 6-1 and 6-2 show bars 611 and 612 having three mounting holes 620. Embodiments of bars 611 and 612 include any number of mounting holes as needed. Additionally, mounting holes 620 are not limited to any particular structures. For example, in one embodiment holes 620 are counter sunk holes that enable the bars to be secured to a mounting bracket by a screw going from top down, screwing into nuts on the bottom side of the mounting bracket. In another embodiment, for illustration purposes only and not by limitation, holes 620 are threaded holes that enable the bars to be secured to a mounting bracket by screws coming up from the bottom side of the mounting bracket and screwing into the bars.

Bars 611 and 612 are also not limited to any particular dimensions. Bars 611 and 612 illustratively have the same or similar features and dimensions as bars 511 and 512 in FIGS. 5-1 and 5-2. For example, length 626 is illustratively between three and twenty-two inches, and the tops of teeth 605 illustratively form a flat or approximately flat surface. Also for example, teeth 605 are illustratively wider than conventional teeth and gaps 615 are not as deep as conventional gaps.

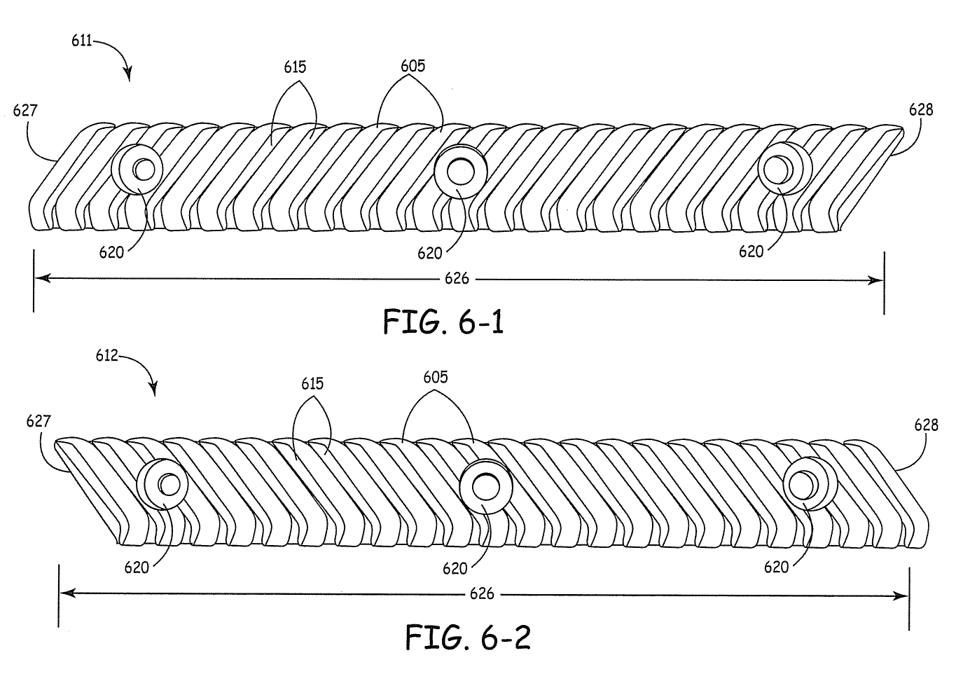

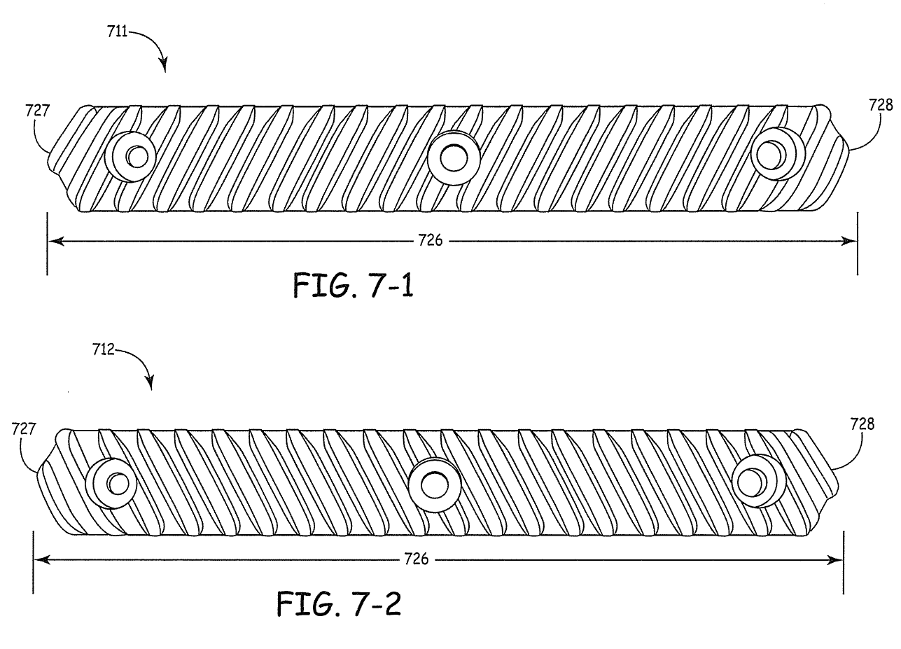

FIG. 7-1 is a top view of another alternative left-handed thresher/separator bar 711, and FIG. 7-2 is a top view of another alternative right-handed thresher/separator bar 712. Bars 711 and 712 include left ends 727 and right ends 728. In an embodiment, the ends are or are approximately “V” shaped. It should be noted that this is different than ends 627 and 628 shown in FIGS. 6-1 and 6-2 that are or are approximately flat and angled causing the bars to have a rhombus type shape when viewed from above. The different shape of ends 727 and 728 (as opposed to ends 627 and 628) allow for bars 711 and 712 to be secured or attached to different types of threshing assembly components such as different types of mounting brackets. In some embodiments, bars 711 and 712 include features and dimensions similar to bars 511, 512, 611, and 612. For example, in an embodiment bar length 726 is between three and twenty-two inches.

Bars 511, 512, 611, 612, 711, and 712 have been described as being either left handed (i.e. teeth going from left to right) or right handed (i.e. teeth going from right to left). Embodiments of the present disclosure are not limited to any particular angles of the teeth, and include all angles including no angle (i.e. straight teeth). Similarly, cylinder or rotor assemblies such as those shown in FIGS. 2-1, 2-2, 3-1, 3-2, 4-1, 4-2, and 4-3 are not limited to any particular configuration of having left handed or right handed bars. Embodiments include all variations. In one embodiment however, bars are placed in a rotor or cylinder such that the bars in the first row (e.g. row 281 in FIG. 2-2) going from top to bottom are left handed, left handed, right handed, right handed, and the bars in the second row (e.g. row 282 in FIG. 2-2) going from top to bottom are right handed, right handed, left handed, and left handed. In another embodiment, that pattern is repeated across the remaining rows in a rotor or cylinder (e.g. it is repeated across rows 283-287 in FIG. 2-2).

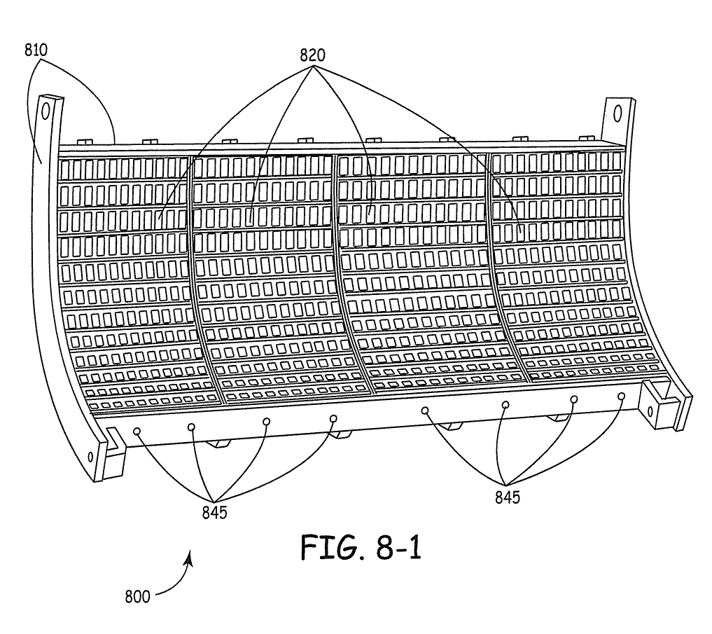

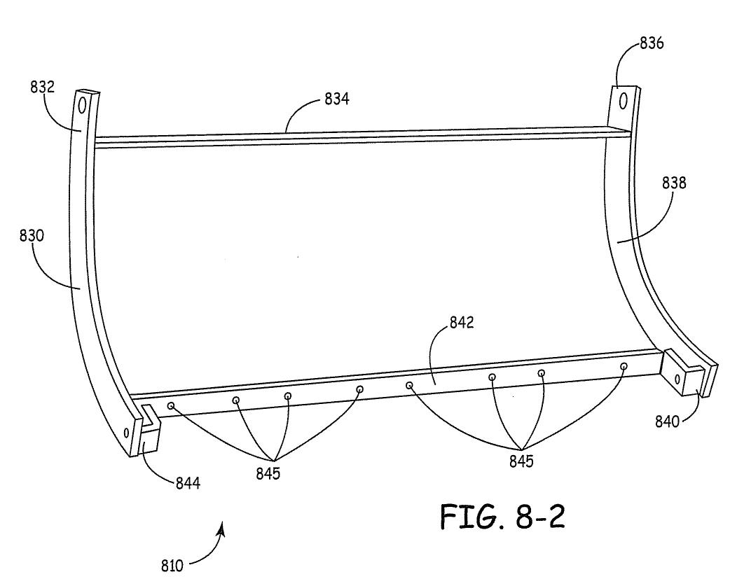

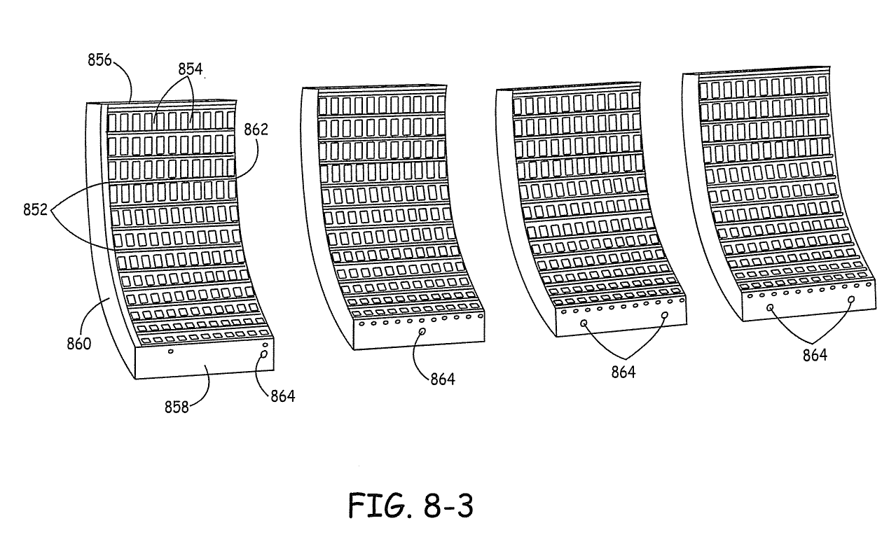

FIG. 8-1 shows a perspective view of a modular concaves assembly 800. Assembly 800 is illustratively used as concaves in a threshing assembly such as concaves 125 shown in FIG. 1. Assembly 800 includes a frame 810 and modules 820. FIG. 8-2 is a perspective view of frame 810, and FIG. 8-3 is a perspective view of modules 820. In assembly 800, modules 820 are mounted in and attached to frame 810. FIGS. 8-1 and 8-3 show an embodiment of assembly 800 with four modules 820. Embodiments are not however limited to any particular number of modules and include from only one module to many modules such as, but not limited to, ten.

Frame 810 illustratively includes left side 830, top left corner 832, top side 834, top right corner 836, right side 838, bottom right corner 840, bottom side 842, and bottom left corner 844. In one embodiment, portions of frame 810 such as top left corner 832, top right corner 836, bottom right corner 840, and bottom left corner 844 have features that allow the frame to be attached to or secured to a threshing assembly such as assembly 100 shown in FIG. 1 or to another part or parts of a combine. Frame 810 also optionally includes a variety of structures such as apertures, threaded apertures, brackets, or hinges such as apertures 845 shown in FIGS. 8-1 and 8-2. These structures illustratively aid or enable modules 820 to be attached to or secured to frame 810.

As is shown in FIG. 8-3, each module illustratively includes ribs 852 that run parallel to a top side 856 and a bottom side 858, and crossbars 854 that run parallel to a left side 860 and a right side 862. Each module optionally includes structures such as apertures, threaded apertures, hinges, or brackets, such as apertures 864 that enable each module to be attached to or secured to a frame 810. In an embodiment, only one of the four sides includes attachment structures. In other embodiments, two, three, and all four of the sides (i.e. top 856, bottom 858, left 860, and right 862) include attachment structures or features.

Embodiments of modules 820 are not limited to any particular structure or layout of ribs 852 or crossbars 854. Those skilled in the art will recognize that the structure and layout of ribs and crossbars are optionally chosen based upon the type of crop or crops being harvested. Additionally, those skilled in the art will recognize that modules 820 do not need to have ribs or crossbars. Other structures, patterns, and layouts are optionally used to optimize the combining process (i.e. to optimize the separation of desirable from undesirable portions of crops).

In one illustrative application, concaves module assembly 800 fits into a combine and is used in the combine instead of a conventional one-piece concaves unit. In such a situation, assembly 800 provides many advantages. For example, the individual components of assembly 800 (i.e. frame 810 and modules 820) are each lighter in weight than a one-piece conventional concaves. Additionally, frame 810 may be left installed or partially installed on a combine while modules 820 are removed and replaced. This is advantageous when handling or installing concaves. Installation or replacement of a conventional concaves commonly requires two people working multiple hours. In contrast, in an embodiment, installation or replacement of modules 820 commonly only requires one person working less than one hour.

Assembly 800 may also illustratively reduce costs commonly associated with conventional concaves. For example, if one module 820 is damaged, only that one module needs to be replaced instead of a whole concaves. Also for example, the positions of modules 820 within a frame 810 may be rotated. This may promote uniform wear across the modules and increase the life time of the assembly. Similarly, the modular nature of the assembly allows for concaves with different design features to be easily interchanged with each other to reduce time required when combining crops with special requirements.

Although combine threshing components have been described with reference to particular embodiments, workers skilled in the art will recognize that changes may be made in form and detail without departing from the spirit and scope of the invention.

What is claimed is:

1. A combine threshing assembly comprising:
a rotatable member having a cylindrical shaped outer surface, wherein each position on the cylindrical shaped outer surface is defined by a distance along the length of the surface and an angle along the circumference of the surface;
a first row of bars secured to the cylindrical shaped outer surface, wherein each bar in the first row is located at a first distance along the length of the surface and wherein each bar in the first row is distributed along the circumference of the surface such that each bar in the first row is separated from each other bar in the first row by at least a first angle that is greater than forty-five degrees; and
a second row of bars secured to the cylindrical shaped outer surface, wherein each bar in the second row is located at a second distance along the length of the surface and wherein each bar in the second row is distributed along the circumference of the surface such that each bar in the second row is separated from each bar in the first row by at least half of the first angle.

2. The combine threshing assembly of claim 1 wherein the first row of bars comprises one bar having a plurality of teeth and wherein each of the plurality of teeth has a flat top.

3. The combine threshing assembly of claim 2 wherein the flat top of each of the plurality of teeth has a length and a width that forms a surface.

4. The combine threshing assembly of claim 3 wherein the surfaces of the teeth are at least approximately coplanar.

5. The combine threshing assembly of claim 4 wherein each of the plurality of teeth has a rounded leading edge and a rounded trailing edge.

6. The combine threshing assembly of claim 1 wherein the first row of bars comprises one bar that has a length that is between three and twenty-two inches.

7. The combine threshing assembly of claim 1 wherein the first row of bars comprises one bar that is left-handed and another bar that is right-handed.

8. The combine threshing assembly of claim 1 wherein the first angle is ninety degrees.

9. The combining threshing assembly of claim 1 wherein the first row of bars secured to the cylindrical shaped outer surface comprises one of the bars in the first row secured to a bracket.

10. The combining threshing assembly of claim 9 wherein the one of the bars comprises a flange that covers at least a portion of the bracket.

11. The combine threshing assembly of claim 1 wherein the rotatable member has a second cylindrical shaped outer surface and the radius of the second cylindrical shaped outer surface is different than the radius of the cylindrical shaped outer surface.

12. A combine threshing assembly comprising:
a rotatable member having a cylindrical shaped outer surface;
a plurality of bars secured to the cylindrical shaped outer surface, wherein the plurality of bars are grouped together in a plurality of rows, wherein the bars in each row are located at approximately the same distance along the length of the rotatable member, wherein the bars in each row are distributed along the circumference of the cylindrical shaped outer surface by an angle greater than forty-five degrees; and
wherein at least one of the plurality of bars has a plurality of teeth having flat tops.

13. The combine threshing assembly of claim 12 wherein at least two of the plurality of rows are staggered.

14. The combine threshing assembly of claim 12 wherein one of the plurality of bars has a length that is between three and twenty-two inches.

15. The combine threshing assembly of claim 12 and further comprising a plurality of discharge paddles.

16. A combine thresher bar comprising:
a plurality of teeth, each tooth having a top, a leading edge, and a trailing edge, wherein the top of each tooth forms a plane, wherein the planes formed by the plurality of teeth are at least approximately coplanar, and wherein the leading and trailing edges are rounded.

17. The combine thresher bar of claim 16 and further comprising:
a leading edge flange.

18. The combine thresher bar of claim 17 and further comprising:
a protective circle.

19. The combine thresher bar of claim 18 wherein the thresher bar is left handed.

20. The combine thresher bar of claim 18 wherein the thresher bar is right handed.
